(19) United States
(12) Patent Application Publication
(10) Pub. No.: US 2026/0277523 A1
(43) Pub. Date: Sep. 17, 2026

(54) CONTROL METHOD OF DISPLAY AND ASSOCIATED CIRCUITRY

(71) Applicant: Realtek Semiconductor Corp., HsinChu (TW)

(72) Inventors: Yuh-Wey Lin, HsinChu (TW); Tsung-Han Li, HsinChu (TW); Bo-Yu Lai, HsinChu (TW)

(73) Assignee: Realtek Semiconductor Corp., HsinChu (TW)

(21) Appl. No.: 19/555,858

(22) Filed: Mar. 3, 2026

(30) Foreign Application Priority Data
Mar. 12, 2025 (TW) 114109039

(51) Int. Cl. G06F 3/14

(52) U.S. Cl. CPC G06F 3/1431; G06F 3/1407; G06F 3/1454

(57) ABSTRACT

The present invention provides a control method of a display is disclosed, wherein the display is a first display, and the control method includes: obtaining second resolution information of at least one second display; combining the second resolution information of the at least one second display with first resolution information of the first display to generate modified resolution information; transmitting the modified resolution information to an image source device; receiving image frame data from the image source device; extracting first frame data from the image frame data, and displaying the first frame data on the first display; and transmitting the image frame data to the at least one second display.

### BACKGROUND OF THE INVENTION

### Field of the Invention

The present invention relates to a display control method, and more particularly to a display control method applied to an extended display.

### Description of the Prior Art

For the convenience of computer users, most current computer system chipsets and operating systems support extended display operations, meaning a single computer can transmit multiple image contents to multiple displays and show them thereon. There are currently two mechanisms for extended display control. One mechanism involves multiple displays separately connected to multiple output ports of the computer. For example, a first display may connect to the computer's High Definition Multimedia Interface (HDMI) connector, and a second display may connect to the computer's Universal Serial Bus (USB) Type-C connector. The computer then transmits the multiple image contents to the first and second displays respectively via the HDMI and USB Type-C connectors using a Single Stream Transport (SST) mode. However, if the computer itself is a laptop, the limited number of output ports on the laptop restricts the quantity of extended displays.

Regarding the second mechanism for extended display control, multiple displays are connected to a single output port of the computer in a daisy-chain fashion. The computer then transmits multiple image contents to the multiple displays through this single output port via a Multi-Stream Transport (MST) mode. However, because some current system chipsets do not support MST mode, and the number of streams supported by MST mode is limited by the system chipset's capabilities, the quantity of extended displays remains restricted.

### SUMMARY OF THE INVENTION

Therefore, one object of the present invention is to provide a display control method applied to an extended display, which enables a computer to transmit multiple image contents to multiple daisy-chained displays via a single output port using a SST mode. Furthermore, this method allows computers that support MST mode to connect to more displays, thereby solving the problems described in the prior art.

In one embodiment of the present invention, a control method of a display is disclosed, wherein the display is a first display, and the control method comprises: obtaining second resolution information of at least one second display; combining the second resolution information of the at least one second display with first resolution information of the first display to generate modified resolution information; transmitting the modified resolution information to an image source device; receiving image frame data from the image source device; extracting first frame data from the image frame data, and displaying the first frame data on the first display; and transmitting the image frame data to the at least one second display.

In one embodiment of the present invention, a circuitry used in a display is disclosed, wherein the display is a first display, and the circuitry comprises a hub and splitter circuit and an image processing circuit. The hub and splitter circuit is configured to obtain second resolution information of at least one second display, combine the second resolution information of the at least one second display with first resolution information of the first display to generate modified resolution information, transmit the modified resolution information to an image source device, receive image frame data from the image source device, extract first frame data from the image frame data, and transmit the image frame data to the at least one second display. The image processing circuit is configured to transmit the first frame data to a display panel of the first display.

In one embodiment of the present invention, a control method of a display is disclosed, wherein the display is a second display, and the control method comprises: obtaining third resolution information of a third display; transmitting the third resolution information of the third display and second resolution information of the second display to a first display, for the first display to generate modified resolution information to an image source device; receiving image frame data from the first display, wherein the image frame data sequentially comprises first frame data, second frame data, and third frame data; extracting the second frame data from the image frame data, and displaying the second frame data on the second display; and extracting the third frame data from the image frame data, and transmitting the third frame data to the third display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an extended display architecture according to an embodiment of the present invention.

FIG. 2 is a schematic diagram of display frame data including first frame data, second frame data, and third frame data.

FIG. 3 is a schematic diagram of an extended display architecture according to an embodiment of the present invention.

FIG. 4 is a flowchart of a display control method according to an embodiment of the present invention.

FIG. 5 is a flowchart of a display control method according to an embodiment of the present invention.

### DETAILED DESCRIPTION

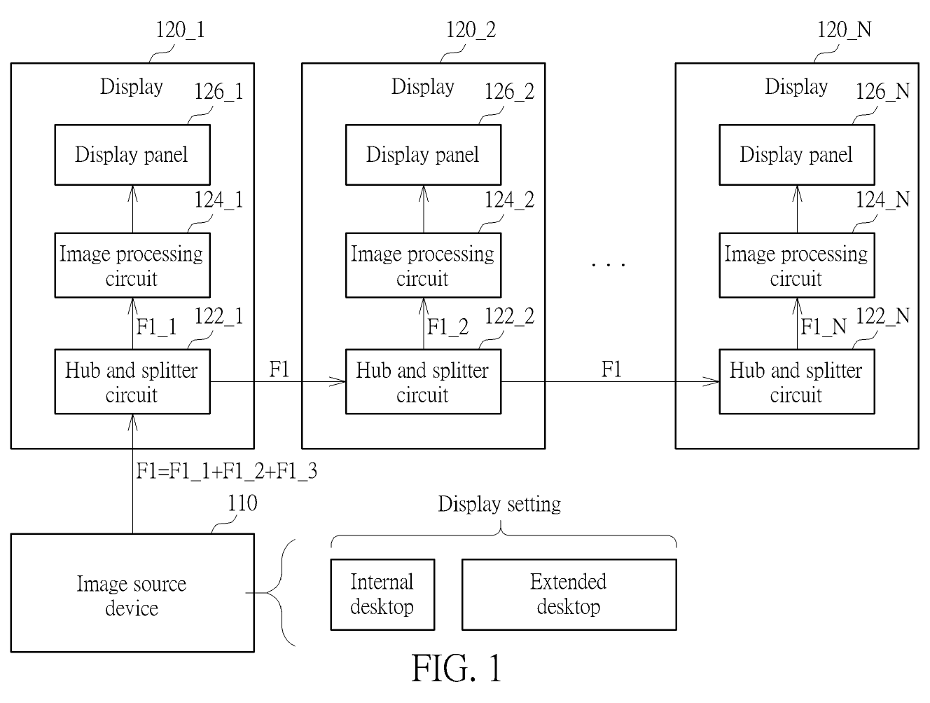

FIG. 1 is a schematic diagram of an extended display architecture according to an embodiment of the present invention. As shown in FIG. 1, the displays 120_1 - 120_N are connected in a daisy-chain fashion. For example, the display 120_1 can connect to the display 120_2 via a connector, such as a DisplayPort (DP) connector or a USB Type-C connector, and a corresponding transmission cable. Similarly, the display 120_2 can connect to the display 120_3 via a connector and a corresponding transmission cable, and so on. Furthermore, the image source device 110 can connect to the first display 120_1 via a DP connector or a USB Type-C connector to transmit image content to each display through the display 120_1. In this embodiment, the image source device 110 can be a desktop computer, a laptop, a smartphone, a tablet computer, or any other electronic device with a screen that supports extended display functionality. The image source device 110 may support only a SST mode, or it may support both SST mode and MST mode.

In this embodiment, the display 120_1 includes a hub and splitter circuit 122_1, an image processing circuit 124_1, and a display panel 126_1. The display 120_2 includes a hub and splitter circuit 122_2, an image processing circuit 124_2, and a display panel 126_2. Similarly, the display 120_N includes a hub and splitter circuit 122_N, an image processing circuit 124_N, and a display panel 126_N. In one embodiment, the hub and splitter circuit 122_1 can be implemented by a hub circuit with splitter circuit.

In one embodiment, the hub and splitter circuit 122_1 and the image processing circuit 124_1 within the display 320_1 can be different chips, or the hub and splitter circuit 122_1 and the image processing circuit 124_1 can be integrated into a single chip.

In the operation of the extended display architecture shown in FIG. 1, first, the first display 120_1 obtains the resolutions and relevant information of all other displays 120_2 - 120_N. Specifically, assuming that the extended display architecture has three displays 120_1 to 120_3, the display 120_2 can obtain the DisplayPort Configuration Data (DPCD), Extended Display Identification Data (EDID), or any other data containing the resolution information of the display 120_3 via an auxiliary channel as defined in the DP specification. Similarly, the display 120_1 can also obtain the DPCD, EDID, or any other data containing the resolution information of the displays 120_2 and 120_3 via an auxiliary channel as defined in the DP specification. Next, after obtaining the resolution information of all other displays 120_2 and 120_3, the display 120_1 combines the resolutions of all daisy-chained displays to obtain modified resolution information. This modified resolution information is then used as the resolution information for the display 120_1 itself, for example, by modifying the resolution information in its own DPCD or EDID. For instance, if the resolutions of displays 120_1 - 120_3 are all Full High Definition (FHD), i.e., 1920*1080, the display 120_1 can horizontally combine the three FHD resolutions to obtain a modified resolution of 5760*1080. In another embodiment, if the resolutions of displays 120_1 - 120_3 are all FHD, the display 120_1 can vertically combine the three FHD resolutions to obtain a modified resolution of 1920*3240.

It should be noted that since the display orientation of displays 120_1 - 120_3 can be changed (e.g., displays can be placed vertically or horizontally), if the resolutions of displays 120_1 - 120_3 are all FHD but their orientation results in a resolution of 1080*1920, then the modified resolution obtained by horizontally or vertically combining the three FHD resolutions by display 120_1 would be 3240*1920 or 1080*5760.

In one embodiment, if the resolutions of displays 120_1 - 120_3 are not completely identical, for example, if the displays 120_1 and 120_3 have a resolution of 1920*1080, but the display 120_2 has a resolution of 2560*1440, then display 120_1 will use the minimum resolution among these three resolutions as the resolution for all displays 120_1 - 120_3 to generate the modified resolution. That is, the resolution of display 120_2 will be considered as 1920*1080, and the modified resolution will then be 5760*1080.

Summarizing the above embodiments, when the quantity of displays is N, and the minimum resolution information among the N resolution information of the N displays is A*B, then the modified resolution information will be (N*A)*B or A*(N*B).

Then, the user controls the image source device 110 to begin using the extended display function. For example, the user can enable the extended display function through the display settings in the Windows operating system. The display settings will include two desktops: an internal desktop displayed on the display panel of the image source device 110, and an extended desktop displayed on the other displays. At this time, the image source device 110 obtains resolution information from the display 120_1. Since the resolution information of display 120_1 has been modified to 5760*1080, the image source device 110 treats this modified resolution of 5760*1080 as the resolution of a single display 120_1. Thus, the resolution of the extended desktop in the display settings will also be set to 5760*1080.

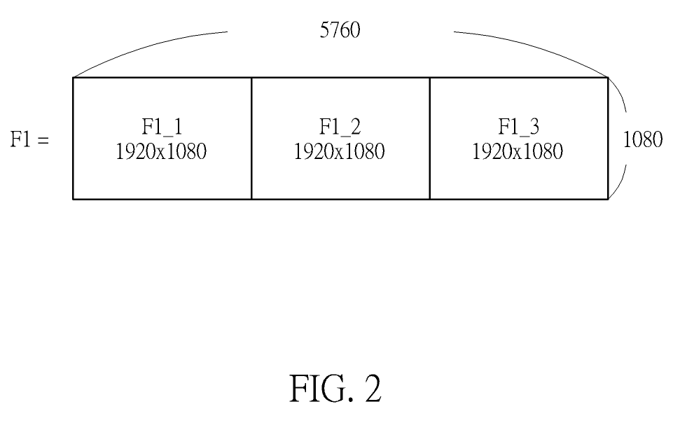

The image source device 110 transmits the extended desktop as image frame data F1 to the display 120_1. Referring to FIG. 2, the image frame data F1 includes first frame data F1_1, second frame data F1_2, and third frame data F1_3. The resolution of the image frame data F1 is the same as the modified resolution that display 120_1 provided to the image source device 110, which is 5760*1080. The resolutions of first frame data F1_1, second frame data F1_2, and third frame data F1_3 are all 1920*1080. In this embodiment, the first frame data F1_1, second frame data F1_2, and third frame data F1_3 represent different contents from one or more applications of the image source device 110, and the image source device 110 transmits the image frame data F1 to the display 120_1 via a SST mode, but the present invention is not limited thereto.

Upon receiving the image frame data F1 from the image source device 110, the hub and splitter circuit 122_1 within the display 120_1 extracts the first frame data F1_1 from the image frame data F1,then transmits the first frame data F1_1 to the image processing circuit 124_1 for some image processing operations, such as image scaling, brightness/chroma adjustment, sharpness adjustment, etc., before displaying it on the display panel 126_1. In another embodiment, the image processing circuit 124_1 transmits the first frame data F1_1 directly to the display panel 126_1 for display without performing any image processing. Furthermore, in this embodiment, the user can configure the hub and splitter circuit 122_1 via an On-Screen Display (OSD) function of the display 120_1, such that the hub and splitter circuit 122_1 automatically extracts the first frame data F1_1 located at the leftmost side of the image frame data F1. Additionally, the hub and splitter circuit 122_1 transmits the entire image frame data F1 to the display 120_2.

Upon receiving the image frame data F1 from the display 120_1, the hub and splitter circuit 122_2 within the display 120_2 extracts the second frame data F1_2 from the image frame data F1, and then transmits the second frame data F1_2 to the image processing circuit 124_2 for some image processing, before displaying it on the display panel 126_2. In another embodiment, the image processing circuit 124_2 transmits the second frame data F1_2 directly to the display panel 126_2 for display without performing any image processing. Furthermore, in this embodiment, the user can configure the hub and splitter circuit 122_2 via an OSD function of the display 120_2, such that the hub and splitter circuit 122_2 automatically extracts the second frame data F1_2 located in the middle of the image frame data F1. Additionally, the hub and splitter circuit 122_2 transmits the entire image frame data F1 to the display 120_3.

Upon receiving the image frame data F1 from the display 120_2, the hub and splitter circuit 122_3 within the display 120_3 extracts the third frame data F1_3 from the image frame data F1, and then transmits the third frame data F1_3 to the image processing circuit 124_3 for some image processing, before displaying it on the display panel 126_3. In another embodiment, the image processing circuit 124_3 transmits the third frame data F1_3 directly to the display panel 126_3 for display without performing any image processing. Furthermore, in this embodiment, the user can configure the hub and splitter circuit 122_3 via an OSD function of the display 120_3, such that the hub and splitter circuit 122_3 automatically extracts the third frame data F1_3 located at the rightmost side of the image frame data F1.

As described above, by using the extended display architecture shown in FIG. 1, the image source device 110 can transmit extended desktop content to two or more displays even when operating in SST mode. This resolves the problem in the prior art where SST mode could only transmit an extended desktop for a single display. Furthermore, since the extended display architecture shown in FIG. 1 can have multiple daisy-chained displays, it also addresses the issue where the number of streams supported when the image source device 110 uses MST mode is limited by the system chipset's capabilities.

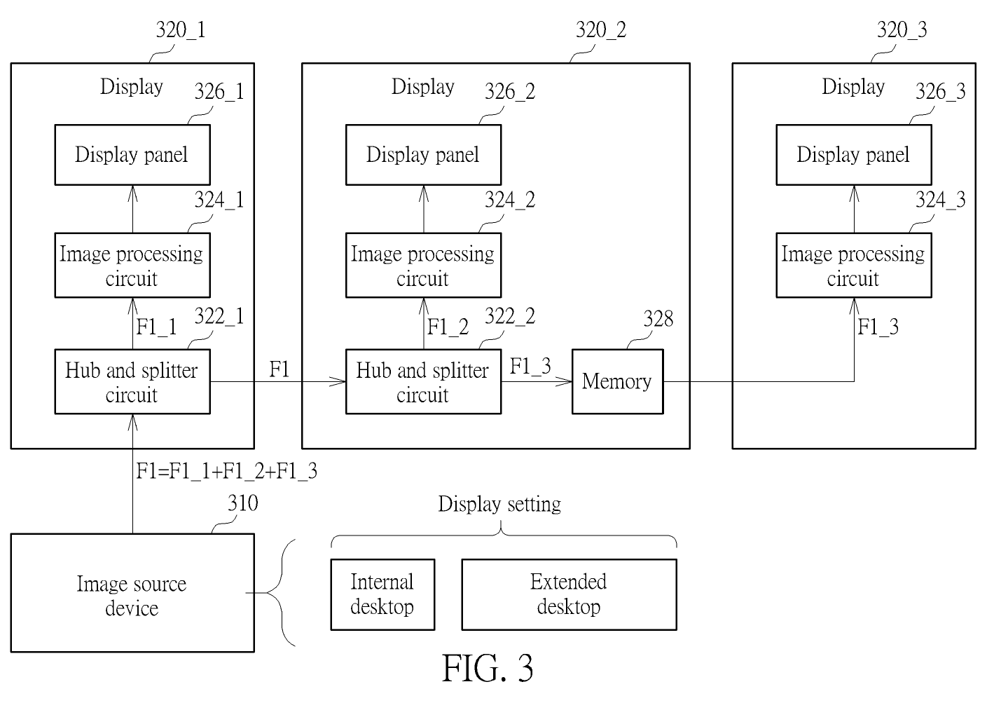

FIG. 3 is a schematic diagram of an extended display architecture according to an embodiment of the present invention. As shown in FIG. 3, multiple displays (e.g., displays 320_1 - 320_3) are connected in daisy-chain fashion. For example, the display 320_1 can connect to the display 320_2 via a connector, such as a DP connector or a USB Type-C connector, and a corresponding transmission cable. Similarly, the display 320_2 can connect to the display 320_3 via a connector and a corresponding transmission cable. Furthermore, the image source device 310 can connect to the first display 320_1 via a DP connector or a USB Type-C connector to transmit image content to each display through the display 320_1. In this embodiment, the image source device 310 can be a desktop computer, a laptop, a smartphone, a tablet computer, or any other electronic device with a screen that supports extended display functionality. The image source device 310 may support only a SST mode, or it may support both SST mode and MST mode.

In this embodiment, the display 320_1 includes a hub and splitter circuit 322_1, an image processing circuit 324_1, and a display panel 326_1. The display 320_2 includes a hub and splitter circuit 322_2, an image processing circuit 324_2, a memory 328, and a display panel 326_2. The display 320_3 includes an image processing circuit 324_3 and a display panel 326_3.

Similar to the embodiment of FIG. 1, in the operation of the extended display architecture shown in FIG. 3, first, the first display 320_1 obtains the resolutions and relevant information of all other displays 320_2 and 320_3, and combines the resolutions of all daisy-chained displays to obtain modified resolution information, which is then used as the resolution information for the display 320_1 itself. For instance, if the resolutions of displays 320_1 - 320_3 are all FHD, the display 320_1 can combine the three FHD resolutions to obtain a modified resolution of 5760*1080.

Next, the user controls the image source device 310 to begin using the extended display functionality. At this time, the image source device 310 obtains resolution information from the display 320_1. Since the resolution information of display 320_1 has been modified to 5760*1080, the image source device 310 treats this modified resolution of 5760*1080 as the resolution of a single display 320_1. Consequently, the resolution of the extended desktop in the display settings will also be set to 5760*1080.

The image source device 310 transmits the extended desktop as image frame data F1 to the display 320_1. Referring to FIG. 2, the image frame data F1 includes first frame data F1_1, second frame data F1_2, and third frame data F1_3. The resolution of the image frame data F1 is the same as the modified resolution that display 320_1 provided to the image source device 310, which is 5760*1080. The resolutions of first frame data F1_1, second frame data F1_2, and third frame data F1_3 are all 1920*1080. In this embodiment, the first frame data F1_1, second frame data F1_2, and third frame data F1_3 represent different content from one or more applications of the image source device 310, and the image source device 310 transmits the image frame data F1 to the display 320_1 via a SST mode, but the present invention is not limited thereto.

Upon receiving the image frame data F1 from the image source device 310, the hub and splitter circuit 322_1 within the display 320_1 extracts the first frame data F1_1 from the image frame data F1, and then transmits the first frame data F1_1 to the image processing circuit 324_1 for some image processing before displaying it on the display panel 326_1. In another embodiment, the image processing circuit 324_1 transmits the first frame data F1_1 directly to the display panel 326_1 for display without performing any image processing. Additionally, the hub and splitter circuit 322_1 transmits the entire image frame data F1 to the display 320_2.

Upon receiving the image frame data F1 from the display 320_1, the hub and splitter circuit 322_2 within the display 320_2 extracts the second frame data F1_2 from the image frame data F1, and then transmits the second frame data F1_2 to the image processing circuit 324_2 for some image processing, before displaying it on the display panel 326_2. In another embodiment, the image processing circuit 324_2 transmits the second frame data F1_2 directly to the display panel 326_2 for display without performing any image processing. Furthermore, since the display 320_2 is the second to last display, the hub and splitter circuit 322_2 also extracts the third frame data F1_3 from the image frame data F1 and temporarily stores the third frame data F1_3 in the memory 328.

Then, the display 320_2 transmits the third frame data F1_3 temporarily stored in the memory 328 to the display 320_3. The image processing circuit 324_3 then performs some image processing on the third frame data F1_3 before displaying it on the display panel 326_3. In another embodiment, the image processing circuit 324_3 transmits the third frame data F1_3 directly to the display panel 326_3 for display without performing any image processing.

As described above, by using the extended display architecture shown in FIG. 3, the image source device 310 can transmit extended desktop content to two or more displays even when operating in SST mode. This resolves the problem in the prior art where SST mode could only transmit an extended desktop for a single display. Furthermore, since the extended display architecture shown in FIG. 3 can have multiple daisy-chained displays, it also addresses the issue where the number of streams supported when the image source device 310 uses MST mode is limited by the system chipset's capabilities. On the other hand, since the extended desktop content required by the last display 320_3 can be obtained by the hub and splitter circuit 322_2 of the second to last display 320_2, the last display 320_3 may not need to include a hub and splitter circuit.

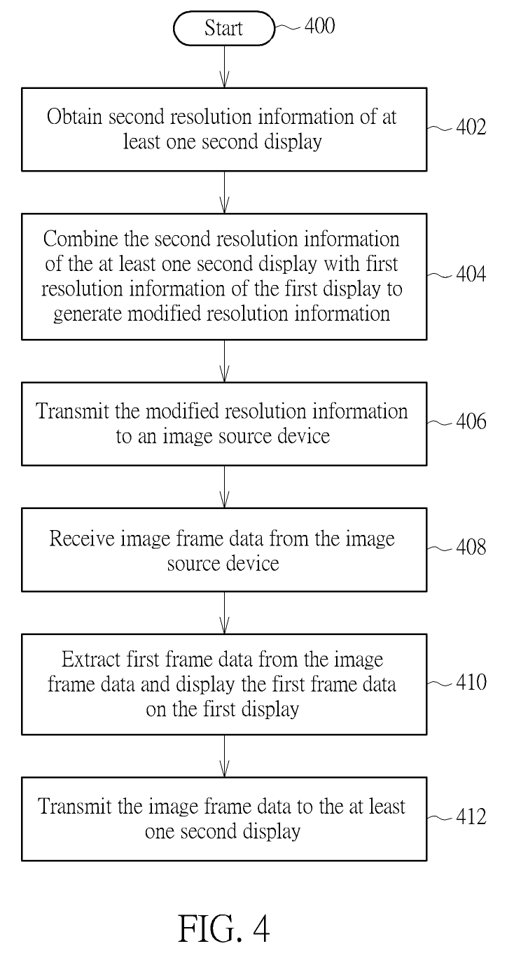

FIG. 4 is a flowchart of a display control method according to an embodiment of the present invention, wherein the control method is executed by a first display. Referring to the above embodiments, the flow is described as follows:

Step 400: The flow starts.

Step 402: Obtain second resolution information of at least one second display.

Step 404: Combine the second resolution information of the at least one second display with first resolution information of the first display to generate modified resolution information.

Step 406: Transmit the modified resolution information to an image source device.

Step 408: Receive image frame data from the image source device.

Step 410: Extract first frame data from the image frame data and display the first frame data on the first display.

Step 412: Transmit the image frame data to the at least one second display.

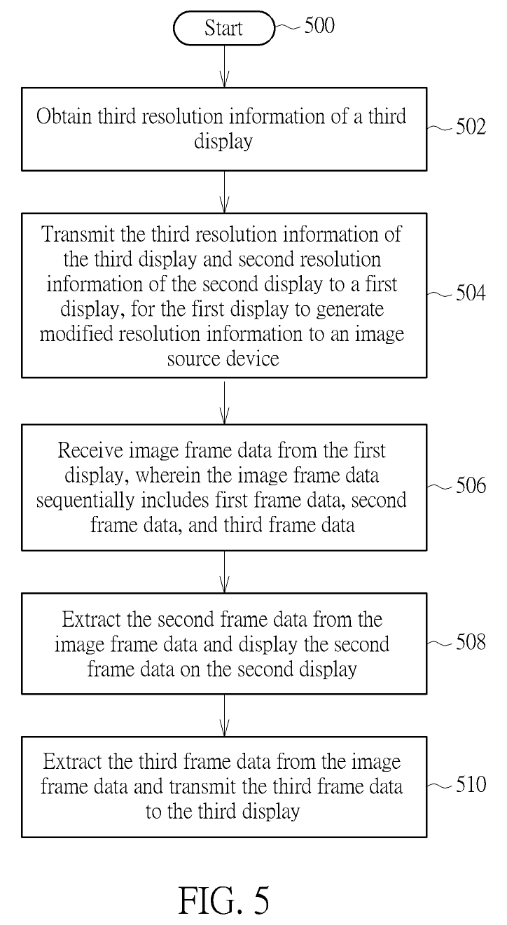

FIG. 5 is a flowchart of a display control method according to an embodiment of the present invention, wherein the control method is executed by a second display. Referring to the above embodiments, the flow is described as follows:

Step 500: The flow starts.

Step 502: Obtain third resolution information of a third display.

Step 504: Transmit the third resolution information of the third display and second resolution information of the second display to a first display, for the first display to generate modified resolution information to an image source device.

Step 506: Receive image frame data from the first display, wherein the image frame data sequentially includes first frame data, second frame data, and third frame data.

Step 508: Extract the second frame data from the image frame data and display the second frame data on the second display.

Step 510: Extract the third frame data from the image frame data and transmit the third frame data to the third display.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a display, wherein the display is a first display, and the control method comprises:
obtaining second resolution information of at least one second display;
combining the second resolution information of the at least one second display with first resolution information of the first display to generate modified resolution information;
transmitting the modified resolution information to an image source device;
receiving image frame data from the image source device;
extracting first frame data from the image frame data, and displaying the first frame data on the first display; and
transmitting the image frame data to the at least one second display.

2. The control method of claim 1, wherein the step of obtaining the resolution information of the at least one second display, and the step of combining the second resolution information of the at least one second display with the first resolution information of the first display to generate the modified resolution information comprise:
obtaining a plurality of second resolution information from a plurality of second displays, wherein the plurality of second displays and the first display are connected in daisy-chain fashion; and
combining the plurality of second resolution information with the first resolution information to generate the modified resolution information.

3. The control method of claim 1, wherein quantity of the at least one second display is (N-1), N is a positive integer greater than or equal to 2, both the first resolution information and the second resolution information are A*B, and the modified resolution information is (N*A)*B or A*(N*B).

4. The control method of claim 1, wherein quantity of the at least one second display is (N-1), N is a positive integer greater than or equal to 2, minimum resolution information among the first resolution information and the second resolution information is A*B, and the modified resolution information is (N*A)*B or A*(N*B).

5. A circuitry used in a display, wherein the display is a first display, and the circuitry comprises:
a hub and splitter circuit, configured to obtain second resolution information of at least one second display, combine the second resolution information of the at least one second display with first resolution information of the first display to generate modified resolution information, transmit the modified resolution information to an image source device, receive image frame data from the image source device, extract first frame data from the image frame data, and transmit the image frame data to the at least one second display; and
an image processing circuit, configured to transmit the first frame data to a display panel of the first display.

6. The circuitry of claim 5, wherein the hub and splitter circuit obtains a plurality of second resolution information from a plurality of second displays, wherein the plurality of second displays and the first display are connected in daisy-chain fashion; and the hub and splitter circuit combines the plurality of second resolution information with the first resolution information to generate the modified resolution information.

7. The circuitry of claim 5, wherein quantity of the at least one second display is (N-1), N is a positive integer greater than or equal to 2, both the first resolution information and the second resolution information are A*B, and the modified resolution information is (N*A)*B or A*(N*B).

8. The circuitry of claim 5, wherein quantity of the at least one second display is (N-1), N is a positive integer greater than or equal to 2, minimum resolution information among the first resolution information and the second resolution information is A*B, and the modified resolution information is (N*A)*B or A*(N*B).

9. A control method of a display, wherein the display is a second display, and the control method comprises:
obtaining third resolution information of a third display;
transmitting the third resolution information of the third display and second resolution information of the second display to a first display, for the first display to generate modified resolution information to an image source device;
receiving image frame data from the first display, wherein the image frame data sequentially comprises first frame data, second frame data, and third frame data;
extracting the second frame data from the image frame data, and displaying the second frame data on the second display; and
extracting the third frame data from the image frame data, and transmitting the third frame data to the third display.

10. The control method of claim 9, wherein resolutions of the first display, the second display, and the third display are all A*B, and a resolution of the image frame data is (3*A)*B or A*(3*B).
